(19) United States
(12) Patent Application Publication
(10) Pub. No.: US 2005/0093195 A1
(43) Pub. Date: May 5, 2005

(54) Method of forming a packaging for flowers and plants, and such packaging

(75) Inventor: Albert Johan Ferdinand Voges, Hillegom (NL)

Correspondence Address: PEACOCK MYERS AND ADAMS P C, P O BOX 26927, ALBUQUERQUE, NM, 871256927, US

(73) Assignee: Voges Verpakking B.V., Hillegom (NL)

(21) Appl. No.: 10/937,167

(22) Filed: Sep. 9, 2004

(30) Foreign Application Priority Data
Sep. 16, 2003 (NL) 1024308

(51) Int. Cl. B29C 53/04

(52) U.S. Cl. 264/153; 264/320

(57) ABSTRACT

A method of forming a packaging for flowers or plants, wherein a sheet of material is unrolled and fed into a thermal moulding machine for heating and subsequently bringing a portion of the sheet of material into a first form, whereafter that portion of the sheet of material is punched and the punched-out portion is further processed into a finished packaging, wherein the first form of the portion of sheet material is shaped substantially as a cylindrical mould, suitable for receiving a plant pot or the like, and this cylindrical mould is provided with a top rim, adjoining to which in a first form is a downward tapering support collar and in that after punching, during the further processing, the support collar is folded upward in relation to the cylindrical mould so as to ready the packaging.

The invention relates to a method of forming a packaging for flowers or plants, wherein a sheet of material is unrolled and fed into a thermal moulding machine for heating and subsequently bringing a portion of the sheet of material into a first form, whereafter that portion of the sheet of material is punched and the punched-out portion is further processed into the finished packaging.

The known method is performed with the aid of a thermomoulding machine, not new in itself, which has the limitation that products fabricated with such a machine cannot be any higher than approximately 10 cm.

It is an object of the invention to provide a method that makes it possible with such a known thermal moulding machine to fabricate a packaging for flowers or plants that may have a height of approximately 18 cm.

With the method according to the invention this is realised by shaping the first form of the portion of sheet material substantially as a cylindrical mould, suitable for receiving a plant pot or the like, and this cylindrical mould being provided with a top rim, adjoining to which in a first form is a downward tapering support collar and that after punching, during the further processing the support collar is folded upward in relation to the cylindrical mould so as to ready the packaging.

In this manner it has surprisingly been shown to be possible to fabricate a packaging for flowers or plants, which in the readied state has a height of 18 cm or more. Therefore the invention is also embodied in such a packaging, which is formed from plastic and which is characterised in that the same comprises a substantially cylindrical mould suitable for receiving a plant pot or the like, and in that this cylindrical mould has a top rim, adjoining to which is a support collar that is adjustable between a first position extending from the top rim downward and a second position extending from the top rim upward.

It is desirable and advantageous for the packaging to be formed as series production that comprises in succession the steps of heating, shaping, punching and stacking, respectively folding over the support collar. In this manner the packaging can be supplied in large numbers and at low costs.

It is further desirable for the sheet of material to be made of plastic selected from the group comprising polyethylene terephthalate, polypropylene, polyethylene and polystyrene.

Hereinbelow the invention will be further elucidated with reference to the drawing.

In the drawing:

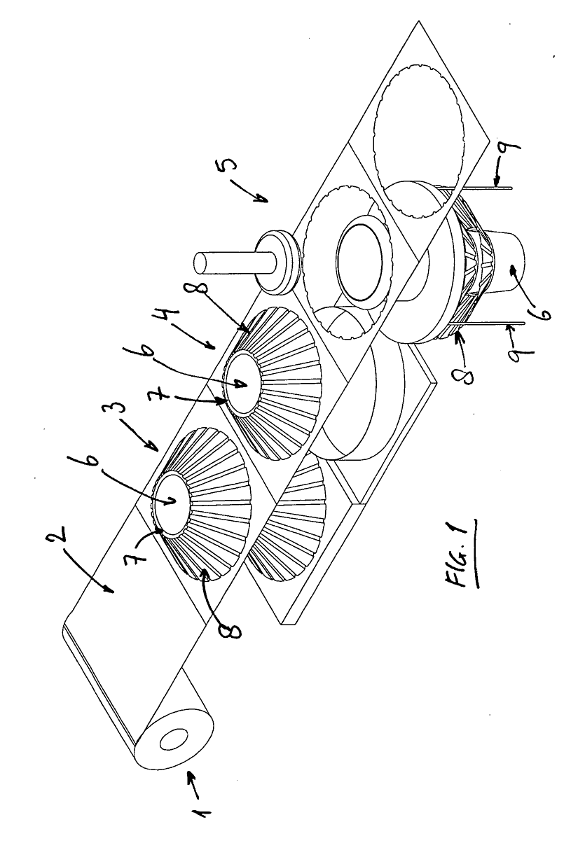

FIG. 1 schematically shows in perspective some of the successive steps in the method for the fabrication of a packaging for flowers or plants according to the invention;

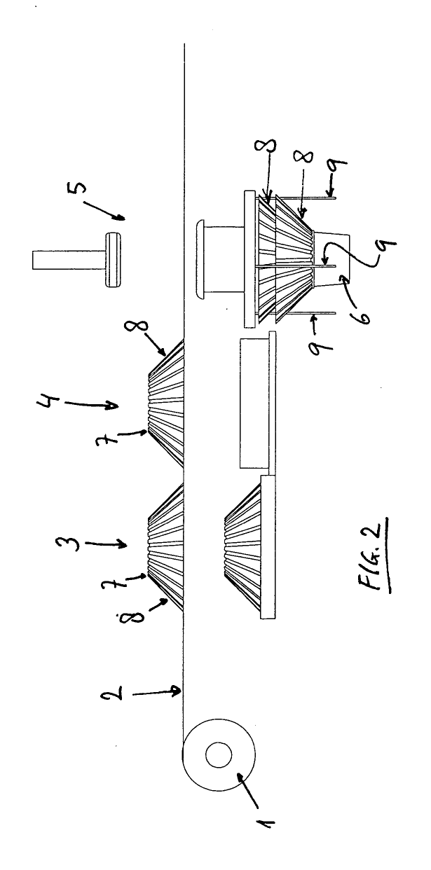

FIG. 2 shows a side elevation of the steps depicted in FIG. 1.

Identical reference numerals used in the figures refer to similar parts.

FIGS. 1 and 2 do not show the thermomoulding machine with which the method according to the invention can be performed. The person skilled in the art is fully acquainted with such a machine so that it does not need to be discussed.

The method of forming a packaging for flowers or plants according to the invention departs from a roll 1 of plastic material. The material is preferably polyethylene terephthalate, but may suitably be selected from the group comprising polyethylene terephthalate, polypropylene, polyethylene and polystyrene.

After the sheet of material from the roll 1 has been fed into the thermomoulding machine, the same is heated in the vicinity indicated with reference numeral 1 and subsequently brought into a first form by means of a moulding step in, for example, a vacuum press. This is symbolised by the part of the figure indicated with reference numeral 3. After this moulding step, the respective portion of the sheet of material is subjected to a punching step as indicated with reference numeral 4.

In a further step 5, the punched out portion is subsequently processed to the desired finished packaging.

As FIG. 1 clearly shows, after the initial forming of the sheet of material in the step indicated with reference numeral 3, the first form of the respective portion of the sheet of material at that moment is shaped as a substantially cylindrical mould 6 that is suitable for receiving a plant pot or the like. This cylindrical mould 6 is provided with a top rim 7, adjoining to which is a downward tapering support collar 8, as shown for the first form indicated with reference numeral 3.

Subsequent to punching, as indicated with reference numeral 4, said support collar 8 is in the further processing folded upward in relation to the cylindrical mould 6, thereby realising the ready packaging. Reference numeral 5 indicates that when the support collar 8 is folded over, the successively fabricated individual packagings are stacked.

From the foregoing elucidation it is clear that the packaging is formed in series production, comprising in succession the steps of heating 2, forming 3, punching 4 and stacking 5 and respectively folding over the support collar 8.

Both in FIG. 1 and FIG. 2 at the right, the individual packaging fabricated in accordance with the invention is shown in the stacked state. The stack is supported by several upright guide elements 9, partly shown in the FIGS. 1 and 2.

1. A method of forming a packaging for flowers or plants, wherein a sheet of material is unrolled and fed into a thermal moulding machine for heating and subsequently bringing a portion of the sheet of material into a first form, whereafter that portion of the sheet of material is punched and the punched-out portion is further processed into the finished packaging, wherein the first form of the portion of sheet material is shaped substantially as a cylindrical mould, suitable for receiving a plant pot wherein the cylindrical mould is provided with a top rim, adjoining to which in a first form is a downward taping support collar, and wherein after punching, during the further processing, the support collar is folded upward in relation to the cylindrical mould so as to ready the packaging.

2. A method according to claim 1, wherein the packaging is formed as a series production that comprises in succession the steps of heating, shaping, punching and stacking, and folding over the support collar.

3. A method according to claim 1, wherein the sheet of material to be made of plastic is selected from the group consisting of polyethylene terephthalate, polypropylene, polyethylene and polystyrene.

4. A packaging for flowers or plants, which packaging is formed from plastic, wherein the same comprises a substantially cylindrical mould suitable for receiving a plant pot, and wherein said cylindrical mould has a top rim, adjoining to which is a support collar that is adjustable between a first position extending from the top rim downward and a second position extending from the top rim upward.
